(19) United States
(12) Patent Application Publication
(10) Pub. No.: US 2011/0052474 A1
(43) Pub. Date: Mar. 3, 2011

(54) INSTALLATION AND METHOD FOR REDUCING THE CONTENT IN ELEMENTS, SUCH AS BORON, OF HALOSILANES

(75) Inventors: Ekkehard Mueh, Rheinfelden (DE); Hartwig Rauleder, Rheinfelden (DE); Reinhold Schork, Rheinfelden (DE)

(73) Assignee: Evonik Degussa GmbH, Essen (DE)

(21) Appl. No.: 12/812,857

(22) PCT Filed: Nov. 20, 2008
(86) PCT No.: PCT/EP08/65902

§ 371 Date: Jul. 14, 2010

(30) Foreign Application Priority Data
Jan. 14, 2008 (DE) 102008004396.6

(51) Int. Cl. C01B 33/107; B01J 19/00

(52) U.S. Cl. 423/342; 422/187

(57) ABSTRACT

The invention relates to a method for reducing the content in elements of the third main group of the periodic system, especially in boron- and aluminum-containing compounds of technically pure halosilanes for producing high-purity halosilanes, especially high-purity chlorosilanes. The invention further relates to an installation for carrying out said method.

The invention relates to a process for reducing the content of elements of the third main group of the Periodic Table, especially of boron and aluminium, in halosilanes of technical-grade purity to prepare ultrahigh-purity halosilanes, especially ultrahigh-purity chlorosilanes. The invention further relates to a plant for performing this process.

The prior art discloses two processes for purifying halosilanes, which are based on the use of triphenyl-methyl chloride in conjunction with further complexing agents. One is the multistage process of GB 975 000, in which phosphorus-containing impurities in halosilanes are distillatively removed, first by adding tin tetrahalides and/or titanium tetrahalides to form solid precipitates. In the next step, triphenylmethyl chloride can be added in a large excess to the resulting distillate in order to form precipitates with the tin salts or titanium salts which are then present. Any further impurities present, which also include boron, aluminium or other impurities, can be removed as precipitates. Distillation was effected in the following step.

WO 2006/054325 A2 discloses a multistage process for preparing electronics-grade silicon tetrachloride (Si_{eg}) or trichlorosilane from silicon tetrachloride or trichlorosilane of technical-grade purity. Proceeding from silicon tetrachloride and/or trichlorosilane of technical-grade purity, boron-containing impurities (BCl₃), among others, are converted to high-boiling complexes in a first step by adding diphenylthio-carbazone and triphenylchloromethane, and removed in the second step by means of column distillation, and phosphorus chlorides (PCl₃) and phosphorus-containing impurities, and arsenic- and aluminium-containing impurities and further metallic impurities are removed as distillation residues in a second column distillation in the third step. It is stated that the use of two complexing agents is necessary to remove all impurities, because triphenylchloromethane allows the complexation of a multitude of metallic impurities with the exception of boron. Only in a fourth step is dichlorosilane removed by distillation.

It is an object of the present invention to develop a simpler and hence more economically viable process and a plant for preparing ultrahigh-purity halosilanes, especially chlorosilanes, which are suitable for production of solar silicon and especially also for production of semiconductor silicon.

The object is achieved by the process according to the invention and the inventive plant according to the features of claims 1 and 10. Preferred variants are described in the dependent claims.

The invention provides a process which allows the preparation of ultra-high purity halosilanes from halosilanes of technical-grade purity, in which the elements of the third main group of the Periodic Table (III PTE), especially boron and/or aluminium, are removed quantitatively, especially proceeding from a hydrohalogenation of metallurgical silicon.

The invention provides a process for reducing the content of elements of the third main group of the Periodic Table, especially the boron and/or aluminium content, in halosilanes of technical-grade purity to prepare ultrahigh-purity halosilanes, consisting of the following steps:
a) admixing the halosilanes to be purified with triphenylmethyl chloride to form complexes with compounds of these elements, especially with boron- and/or aluminium-containing compounds, and
b) obtaining ultrahigh-purity halosilanes by distillatively removing the complexes, especially by a single distillation.

In order to obtain the ultrahigh-purity halosilanes directly, the complexes formed are, in accordance with the invention, removed by means of a single distillation of the reaction mixture from step a) using a distillation column, for example—but not exclusively—using a rectification column having one to a 100 theoretical plates. The complexes formed advantageously remain in the distillation residue. Inventive ultrahigh-purity halosilanes have a boron and aluminium impurity content of in each case ≦50 μg/kg in relation to the element per kilogram of halosilane.

It is particularly preferred when the halosilanes of technical-grade purity have not been subjected beforehand to any removal of phosphorus or phosphorus-containing compounds and/or the ultrahigh-purity halosilanes are not subjected to any subsequent removal of phosphorus and/or phosphorus-containing compounds. More particularly, the phosphorus content in the halosilanes of technical-grade purity is already below 4 μg/kg, preferably <2 μg/kg, especially <1 μg/kg; the same applies to the ultrahigh-purity halosilanes. The phosphorus content is determined by means of a method familiar to the competent skilled analyst. One example is ICP-MS, the phosphorus content in the sample being enriched beforehand by customary methods.

The boron content in the ultrahigh-purity halosilanes obtained is preferably ≦20 μg/kg and more preferably ≦5 μg/kg of boron per kilogram of halosilane. The distillative purification of the preferred halosilanes, silicon tetrachloride and trichlorosilane, is generally effective at top temperatures of about 31.8° C. and 56.7° C., and a pressure of about 1013.25 hPa or 1013.25 mbar_{abs}. At higher or lower pressures, the top temperature changes correspondingly. In the case of volatile halosilanes, it may be appropriate to distil under elevated pressure.

In an alternative embodiment, the process according to the invention can be performed in such a way that step (a), the admixing of the halosilanes to be purified with triphenylmethyl chloride to form the complexes, is effected in an apparatus for complexation (2), from which the halosilanes and the complexes are transferred at least partly, preferably completely, into a distillation column (3) for removing the complexes in step (b). In an alternative process regime, step (a) is effected separately from step (b), especially spatially separately. The boron- and aluminium-containing complexes are quantitatively removed using the distillation column (3). According to the invention, steps (a) and (b) are incorporated into a continuous process for preparing ultrahigh-purity halosilanes, preferably proceeding from a conversion of metallurgical silicon, especially proceeding from a hydrohalogenation of metallurgical silicon.

The reason for the advantage of this process regime is that the complexation is separated from the removal and, in this way, the removal of boron- and/or aluminium-containing compounds can be integrated into a continuous overall process. This can be done, for example, in such a way that at least one apparatus for complexation (2) is, preferably a plurality of apparatuses (2) connected in parallel are, assigned to a distillation column (3). Alternatively, series-connected apparatuses for complexation are each assigned to a distillation column (3). The apparatus or apparatuses for complexation (2) may, for example, be filled with or flowed through by halosilanes batchwise or continuously—batch reactor or tubular reactor—and the content of boron and optionally further impurities can be determined analytically. Subsequently, the halosilanes to be purified are admixed with triphenylmethyl chloride, preferably with a slight excess of ≦20 mol %, ≦10 mol %, preferably of ≦5 mol % or less. The resulting reaction mixture can be homogenized in order to ensure complete complexation of the boron- and/or aluminium-containing compounds.

The homogenization can be effected by stirring or, in the tubular reactor, by vortexing. Subsequently, the halosilanes and, if appropriate, the complexes are transferred into the distillation column (3) or into the assigned distillation still. This is followed in accordance with the invention by the distillative removal of the halosilanes and the complexes, in order to obtain ultrahigh-purity halosilanes.

By virtue of the batchwise complexations performed semicontinuously or continuously and in parallel (step a) and of the subsequent distillative removal of the halosilanes, the process according to the invention can be integrated into a continuous overall process for preparing ultrahigh-purity halosilanes proceeding from a hydrohalogenation of metallurgical silicon.

Elements in the third main group of the Periodic Table (IIIa PTE) which are relevant to the process, the content of which in the halosilanes of technical-grade purity is to be reduced, are especially boron and/or aluminium, and process-related compounds containing boron and/or aluminium. In general, the triphenylmethyl chloride can form complexes with all typical Lewis acids. These may, as well as boron and aluminium, also be tin, titanium, vanadium and/or antimony, or compounds containing these extraneous metals.

Halosilanes are preferably understood to mean chlorosilanes and/or bromosilanes, particular preference being given to silicon tetrachloride, trichlorosilane and/or mixtures of these silanes, optionally with further halogenated silanes, such as dichlorosilane and/or monochlorosilane. The process is therefore generally very suitable for reducing the content of elements of the third main group of the Periodic Table in halosilanes when these compounds have a comparable boiling point or boiling point range to the halosilanes or would distil over as an azeotrope with the halosilanes and/or in which the solubility of the complexes formed is correspondingly low. Some compounds containing elements of the third main group of the Periodic Table can therefore be removed from the halosilanes by distillation only with difficulty, if at all. A boiling point within the range of the boiling point of a halosilane is considered to be a boiling point which is within the range of ±20° C. of the boiling point of one of the halosilanes at standard pressure (about 1013.25 hPa or 1013.25 mbar).

Appropriately, the process can also be employed to purify tetrabromosilane, tribromosilane and/or mixtures of halosilanes. Generally, every halogen in the halosilanes may be selected independently from further halogen atoms from the group of fluorine, chlorine, bromine and iodine, such that, for example, mixed halosilanes such as SiBrCl₂F or SiBr₂ClF may also be present. In addition to these preferably monomeric compounds, it is, however, also possible to correspondingly reduce the boron content of dimeric or higher molecular weight compounds, such as hexachlorodisilane, decachlorotetrasilane, octachloro-trisilane, pentachlorodisilane, tetrachlorodisilane and liquid mixtures containing monomeric, dimeric, linear, branched and/or cyclic oligomeric and/or polymeric halosilanes.

Halosilanes of technical-grade purity are understood to mean especially halosilanes whose content of halosilanes is ≧97% by weight and whose content of elements of the third main group of the Periodic Table is in each case ≦0.1% by weight, preferably in the range from ≦0.1% by weight to ≧100 μg/kg, more preferably in the range from ≦0.1% by weight to >30 μg/kg. They preferably have at least a content of 99.00% by weight, especially a content of at least 99.9% by weight of the desired halosilane(s). For example, the composition may have a content of 97.5% by weight of silicon tetrachloride (SiCl₄) and 2.2% by weight of trichlorosilane (HSiCl₃), or about 85% by weight of SiCl₄ and 15% by weight of HSiCl₃, or else 99.0% by weight of silicon tetrachloride. It is preferred when the phosphorus content in the halosilanes of technical-grade purity is already below μg/kg, more preferably <2 μg/kg, especially <1 μg/kg, especially without the content of phosphorus having been removed by formation of precipitates.

Ultrahigh-purity halosilanes are considered to be halosilanes with a content of halosilanes of ≧99.9% by weight and having a maximum contamination by any element of the third main group of the PTE, especially by boron- and also by aluminium-containing compounds, of ≦30 μg/kg in relation to the element per kilogram of halosilane, especially of ≦25 μg/kg, preferably of ≦2 μg/kg, ≦15 μg/kg or ≦10 μg/kg, particular preference being given to a contamination of ≦5 μg/kg, ≦2 μg/kg or ≦1 μg/kg per element in the halosilane, in accordance with the invention by each of boron and aluminium.

In a preferred embodiment, halosilanes of technical-grade purity are considered to be especially halosilanes, which also include halosilane mixtures, having a content of halosilanes of ≧97% by weight and a content of elements of the third main group of the Periodic Table of in each case ≦0.1% by weight, preferably with a content of elements between ≦0.1% by weight and ≧6 μg/kg, more preferably between ≦0.1% by weight and >5 μg/kg, and the ultrahigh-purity halosilanes are considered to be the halosilanes which have a content of halosilanes of ≦99.99% by weight and a maximum contamination with any one element of the third main group of the PTE, especially by boron- and especially by aluminium-containing compounds, of ≦5 μg/kg in relation to the element per kilogram of halosilane.

Boron-containing compounds are, for example, boron trichloride or boric esters. In general, however, all boron-containing compounds which are produced in the synthesis of the halosilanes or entrained into the processes can be reduced down to a residual content of especially ≦20 μg/kg, preferably of ≦5 μg/kg, ≦2 μg/kg, more preferably to ≦1 μg/kg, of boron per kilogram of halosilane. In general, boron and/or a boron-containing compound, depending on the starting concentration thereof, can be reduced by 50 to 99.9% by weight. The same applies to aluminium or to aluminium-containing compounds. A typical aluminium-containing compound is AlCl₃.

According to the invention, in process step a) of the process, the complex-forming compound triphenylmethyl chloride is preferably added in such an amount that the solubility product of the complex(es) of an element of the third main group of the Periodic Table (IIIa PTE) formed with triphenylmethyl chloride is exceeded, more particularly of the compounds containing this element, more preferably of the boron- and/or aluminium-containing compounds, and a sparingly soluble complex forms. It is particularly preferred that the amount of triphenylmethyl chloride added is such that this compound is added only in a slight excess of about ≦20 mol %, especially ≦10 mol %, more preferably ≦5 mol %, in relation to the contamination with elements of the third main group of the Periodic Table.

Therefore, before the admixing with triphenylmethyl chloride, the content of impurities in the halosilanes of technical-grade purity should be determined, more particularly of the elements of IIIa of the PTE and of any further impurities which form sparingly volatile and/or sparingly soluble complexes with triphenylmethyl chloride. These are especially the boron- and/or aluminium-containing compounds detailed above. The content can be determined, for example, by means of ICP-MS. Depending on the contents of these elements (IIIa PTE) and/or of any further impurities which react with triphenylmethyl chloride, the amount of triphenylmethyl chloride required can then be determined.

To date, in the prior art, triphenylmethyl chloride has been added in a distinct excess relative to the boron compounds present. In the process according to the invention, the amount of triphenylmethyl chloride required can be matched to the degree of contamination. In this way, it is possible to match the amount of triphenylmethyl chloride added, for example, more accurately to the solubility product of the sparingly soluble boron and/or aluminium complexes in an environmentally benign manner. For better understanding of the procedure, reference is made to the details in the use examples.

The triphenylmethyl chloride can be added in process step a) by a single metered addition or else stepwise. According to the plant type or process regime, the addition can be effected in solid form or else dissolved in a solvent. The solvents used may be inert high-boiling solvents or preferably ultrahigh-purity halosilane, such as silicon tetrachloride and/or trichlorosilane. In this way, the metered addition of the triphenylmethyl chloride can be controlled very accurately and good mixing can be achieved within a short time.

The halosilanes of technical-grade purity are generally admixed with triphenylmethyl chloride under a protective gas atmosphere, optionally while stirring. This is suitably followed by stirring for several hours. Typically, the reaction mixture is stirred for in the range from 5 minutes up to 10 hours, generally up to one hour. This is followed by distillative workup. As required, the process regime may be batchwise or continuous.

Examples 1a to 1d show that the boron content can be reduced directly after addition of the triphenylmethyl chloride by the distillative workup for removal of the sparingly soluble complexes. A certain residence time of the reaction mixture does not lead to any further reduction in the boron content in the ultrahigh-purity halosilanes. Similarly, a thermal treatment of the reaction mixture in the manner of heating to complete the reaction is not absolutely necessary.

The halosilanes prepared in this way, especially the ultrahigh-purity silicon tetrachloride and/or trichlorosilane, can be used to produce epitaxial layers, to produce silicon for the production of mono-, multi- or polycrystalline ingots or of wafers for production of solar cells or for production of ultrahigh-purity silicon for use in the semiconductor industry, for example in electronic components, or else in the pharmaceutical industry for preparation of SiO₂, for production of light waveguides or further silicon-containing compounds.

The invention further provides a plant (1), and the use thereof, for reducing the content of elements of the third main group of the Periodic Table (IIIa PTE), especially the boron and/or aluminium content, in halosilanes of technical-grade purity to prepare ultrahigh-purity halosilanes, comprising an apparatus for complexation (2) of compounds of these elements, to which is especially assigned a metering apparatus, and a distillation column (3) assigned to the apparatus for complexation.

In a preferred alternative, the plant (1) for reducing the content of elements of the third main group of the Periodic Table (IIIa PTE), especially the boron and aluminium content, in halosilanes of technical-grade purity to prepare ultrahigh-purity halosilanes consists of an apparatus for complexation (2), to which is especially assigned a metering apparatus, and of a distillation column (3) assigned to the apparatus (2).

In a further alternative inventive plant (1), the distillation column (3) is connected downstream of at least one apparatus for complexation (2); more particularly, the distillation column (3) is separated from the apparatus for complexation (2). This allows integration of the plant (1) into an overall plant for preparing ultrahigh-purity halosilanes proceeding from a hydrohalogenation of metallurgical silicon, for example into a continuous overall plant. The apparatus for complexation (2) may have reactors connected in parallel and/or in series, such as batch reactors and/or tubular reactors, for semicontinuous or continuous complexation and homogenization of the reaction mixture, to which are assigned at least one downstream distillation column (3) for removal of the halosilanes from the complexes. Appropriately, a distillation column (3) is assigned to each of the series-connected reactors. A distillation still and at least one distillation receiver to receive the ultrahigh-purity halosilanes are assigned to the distillation column (3). The distillation column (3), especially a rectifying column, has between 1 and 100 theoretical plates.

At the top of the column, the distillatively purified product fractions of the ultrahigh-purity halosilanes, such as silicon tetrachloride and/or trichlorosilane, are obtained, while the soluble and/or sparingly volatile complexes remain in the distillation still. The plant can be operated in batch operation or continuously.

The plant (1) may be part of a larger plant which serves to prepare ultrahigh-purity halosilanes proceeding from metallurgical silicon; more particularly, the plant (1) is assigned to an overall plant comprising a reactor for conversion of metallurgical silicon.

The examples which follow illustrate the process according to the invention in detail, without restricting the invention to these examples.

### EXAMPLES

Determination of the boron content: The samples were prepared and analysed in a manner familiar to the skilled analyst, by hydrolysing the sample with demineralized water and treating the hydrolysate with hydrofluoric acid (superpure) to eliminate silicon in the form of volatile silicon tetrafluoride. The residue was taken up in demineralized water and the element content was determined by means of ICP-MS (ELAN 6000 Perkin Elmer).

### Example 1

### General Process Procedure

Silicon tetrachloride and triphenylmethyl chloride were weighed as rapidly as possible into a beaker on a balance with the precision appropriate in each case. The amount of trimethyl chloride added was determined by reweighing the weighing pan. In general, a yellow, flocculent precipitate formed directly after addition of the complexing agent. This did not change the temperature of the reaction mixture. The reaction mixture was then transferred into a 500 ml four-neck flask. Thereafter, one batch was boiled under reflux for one hour before the distillative purification of the silicon tetrachloride. All further batches were worked up by distillation directly.

The distillation was effected using a distillation column with ceramic saddles (6 mm, 20 cm) and a column head without withdrawal control, by stirring using a magnetic stirrer bar under a nitrogen atmosphere. Heat was supplied using a temperature-controlled oil bath. The bath temperature was about 80° C. during the distillation and the temperature in the distillation still towards the end of a distillation was up to 60° C. The boiling point of the silicon tetrachloride was about 57° C. at standard pressure.

### Example 1a

The reaction mixture composed of 201.0 g of silicon tetrachloride (sample 1: GC purity 97.5% by weight of SiCl₄, 2.2% by weight of SiHCl₃) and 0.27 g of triphenylmethyl chloride (Acros, purity 99%) was heated under reflux for one hour, before the distillation of the silicon tetrachloride was performed. The triphenylmethyl chloride content corresponded to 0.134% by weight in relation to the amount of the halosilane used. After the addition of the triphenylmethyl chloride, a yellow, flocculent precipitate formed. 182.3 g of colorless, clear distillate were obtained. The distillation residue was 6.5 g. The boron content was reduced from 880 μg/kg before the addition of the triphenylmethyl chloride to <5 μg/kg after the distillation.

### Example 1b

The reaction mixture composed of 199.6 g of silicon tetrachloride (sample 1: GC purity 97.5% by weight of SiCl₄, 2.2% by weight of SiHCl₃) and 0.01 g of triphenylmethyl chloride (Acros, purity 99%) was purified by distillation directly after the addition of the complexing agent. The triphenylmethyl chloride content corresponded to 0.005% by weight in relation to the amount of the halosilane used. After the addition of the triphenylmethyl chloride, a yellow, flocculent precipitate formed. 186.8 g of a colorless, clear distillate and 9.7 g of a distillation residue were obtained. The boron content was 880 μg/kg before the addition of the triphenylmethyl chloride and <5 μg/kg after the distillation.

### Example 1c

The reaction mixture composed of 401.7 g of silicon tetrachloride (sample 2: GC purity 99% by weight of SiCl₄) and 0.01 g of triphenylmethyl chloride (Acros, purity 99%) was purified by distillation directly after the addition of the complexing agent. The triphenylmethyl chloride content corresponded to 0.002% by weight in relation to the amount of the chlorosilane used. After the addition of the triphenylmethyl chloride, a yellow, flocculent, well-dispersed precipitate formed. 380.0 g of a colorless, clear distillate were isolated, and 14.8 g remained as distillation residue. The boron content was reduced from 289 μg/kg before the addition of the triphenylmethyl chloride to <5 μg/kg after the distillation.

### Example 1d

The reaction mixture composed of 400.1 g of silicon tetrachloride (sample 2: GC purity 99% by weight of SiCl₄) and 0.0052 g of triphenylmethyl chloride (Acros, purity 99%) was purified by distillation directly after the addition of the complexing agent. The triphenylmethyl chloride content corresponded to 0.001% by weight in relation to the amount of the chlorosilane used. After the addition of the triphenylmethyl chloride, a yellow, flocculent, well-dispersed precipitate formed. 375.3 g of a colorless, clear distillate, and 19.7 g of a distillation residue were obtained. The boron content was reduced from 289 μg/kg before the addition of the triphenylmethyl chloride to 5 μg/kg after the distillation.

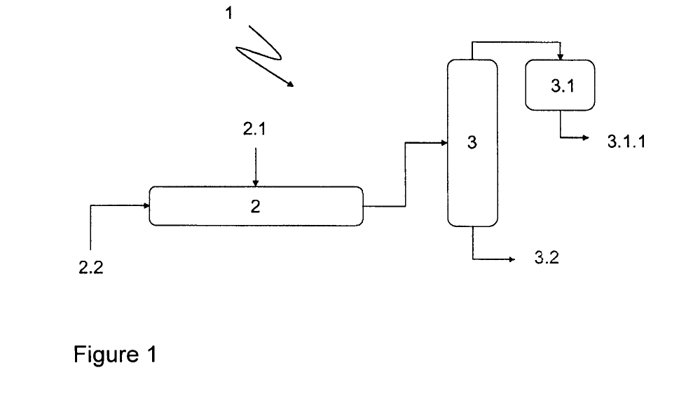

The inventive plant is illustrated in detail hereinafter with reference to the working example shown schematically in FIG. 1. The FIGURE shows:

FIG. 1: Schematic diagram of a plant with distillation column.

The plant (1) shown in FIG. 1 for reducing the content of elements of the third main group of the Periodic Table in halosilanes is manufactured from a material which is stable to the reaction conditions, for example from a stainless steel alloy. The plant (1) comprises an apparatus for complexation (2) of compounds containing these elements, and a distillation column (3) assigned to the apparatus. The apparatus for complexation (2) is generally a reactor, which may be a tank reactor or a tubular reactor, to which a distillation column (3) is assigned. The apparatus for complexation (2) possesses one or two feeds (2.1) and (2.2). The feed (2.1) can be used to supply the triphenylmethyl chloride, and the feed (2.2) to supply the halosilanes of technical-grade purity. A distillation still for removing relatively high-boiling impurities and complexes with triphenylmethyl chloride (3.2) and at least one distillation receiver (3.1) for receiving one ultrahigh-purity halosilane each are assigned to the distillation column having one to 100 theoretical plates. The distillation column (3) is arranged downstream of the apparatus for complexation (2). For exact metered addition of the amount of triphenylmethyl chloride, a metering apparatus (not shown) may be assigned to the complexing apparatus (2).

1. A process for reducing the content of elements of the third main group of the Periodic Table in halosilanes of technical-grade purity to prepare ultrahigh-purity halosilanes, said process consisting of:
a) admixing the halosilanes to be purified with triphenylmethyl chloride to form complexes with compounds of these elements, and
b) obtaining ultrahigh-purity halosilanes by distillatively removing said complexes.

2. The process according to claim 1,
wherein
step (a), the admixing of the halosilanes to be purified with triphenylmethyl chloride to form the complexes, is effected in an apparatus for complexation, from which the halosilanes and the complexes are transferred at least partly into a distillation column for removing the complexes in step (b).

3. The process according to claim 1,
wherein
steps (a) and (b) are incorporated into a continuous process for preparing ultrahigh-purity halosilanes proceeding from the conversion of metallurgical silicon.

4. The process according to claim 1,
wherein
the boron and/or aluminium content is reduced.

5. The process according to claim 1,
wherein
the boron and aluminium content is reduced.

6. The process according to claim 1,
wherein
the halosilanes are chlorosilanes.

7. The process according to claim 6,
wherein
the halosilanes are tetrachlorosilane and/or trichlorosilane.

8. The process according to claim 1,
wherein
the content of impurities is determined in the halosilanes of technical-grade purity which form complexes with triphenylmethyl chloride.

9. The process according to claim 1,
wherein
ultrahigh-purity halosilanes are obtained with a content of each element of the third main group of the Periodic Table of ≦30 μg/kg.

10. A plant for reducing the content of elements of the third main group of the Periodic Table in halosilanes of technical-grade purity to prepare ultrahigh-purity halosilanes, comprising at least one apparatus for complexation of compounds containing these elements and a distillation column assigned to the apparatus.

11. The plant according to claim 10,
wherein
the distillation column is connected downstream of at least one apparatus for complexation.

12. The plant according to claim 10,
wherein
a distillation still and at least one distillation receiver are assigned to the distillation column.

13. The plant according to claim 10,
wherein
a metering apparatus is assigned to the apparatus for complexation.

14. The plant according to claim 10,
wherein
the plant is assigned to an overall plant comprising a reactor for converting metallurgical silicon.

15. A plant for performing a process according to claim 1.
